(19) United States
(12) Patent Application Publication
(10) Pub. No.: US 2009/0153587 A1
(43) Pub. Date: Jun. 18, 2009

(54) MIXED REALITY SYSTEM AND METHOD FOR SCHEDULING OF PRODUCTION PROCESS

(75) Inventors: Hyun KANG, Daejeon (KR); Gun Lee, Daejeon (KR); Wookho Son, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/334,120

(22) Filed: Dec. 12, 2008

(30) Foreign Application Priority Data
Dec. 15, 2007 (KR) 10-2007-0131828

(51) Int. Cl. G09G 5/00

(52) U.S. Cl. 345/632; 345/475

(57) ABSTRACT

A mixed reality system includes a camera for providing captured image information in an arbitrary work environment; a sensing unit for providing sensed information based on operation of the camera; a process simulation unit for performing simulation on part/facility/process data of the arbitrary work environment, which is stored in a process information database (DB); a process allocation unit for handling allocation status between the data and simulation information; a mixed reality visualization unit for receiving the captured information and the sensed information, determining a location of the process allocation unit, combining the captured information and sensed information with the simulation information, and then outputting resulting information; and a display-based input/output unit for displaying mixed reality output information from the mixed reality visualization unit and inputting information requested by a user. Further, there is provided a method of implementing the same.

### CROSS-REFERENCE(S) TO RELATED APPLICATIONS

The present invention claims priority of Korean Patent Application No. 10-2007-0131828, filed on Dec. 15, 2007, which is incorporated herein by reference.

### FIELD OF THE INVENTION

The present invention relates to a technology for implementing mixed reality at a work site, and, more particularly, to a mixed reality system for planning and verifying a process, and a method of implementing the same.

This work was supported by the IT R&D program of MIC/IITA. [2005-S-604-02, Realistic Virtual Engineering Technology Development]

### BACKGROUND OF THE INVENTION

In order to verify a new work process in a manufacturing site, a series of processes for performing simulation of the work process through the computerization of relevant data and producing verification data using a verification algorithm are required.

To this end, Computer-Aided Design (CAD) type data is converted and processed by collecting and analyzing manufacturing site data at an actual manufacturing site, and software related to virtual production may be applied so that robot simulation can be performed. Here, most production data corresponds to the business secrets of each manufacturer because of the nature of the production data, and thus the business prefers to use a method of directly purchasing software personally and managing it through the internal development of specialist or the commitment of research rather than to entrust the production data to a professional business.

However, in the case of small-sized businesses, there are many cases in which computerization work has not been performed. Although the computerization work is proceeded, a lot of trial and error must be repeatedly gone through in order to apply a new process to a work site because enormous start-up expenses are required.

With regard to conventional mixed reality systems, there are a first prior art U.S. Pat. No. 6,597,346 entitled “Hand held Computer with See-through Display” and a second prior art U.S. Pat. No. 7,139,685 entitled “Video-supported Planning of Equipment Installation and/or Room Design”.

First, the first prior art supports mixed reality using a see-through-type “Head Mounted Display”. The first prior art proposes a see-through-type display as a hand held computer display, and relates to a system worn on the face like glasses to display computer information while basically viewing an outside environment.

The second prior art handles a technology for allocating virtual furniture in a real environment when the designing an interior of a building using a video recorder. The second prior art enables a user to select virtual furniture in a real room and determine the location of the furniture in the real room by putting virtual objects into a library and simultaneously supporting the images of a real environment and the virtual objects.

However, the first prior art has a disadvantage in that the sensibility and response speed of a tracking sensor must be high because the head of a person often moves.

Further, the second prior art has a disadvantage in that it handles the verification of a process in virtual engineering only on the movement of the allocation of 3-dimensional objects or modification to other objects.

### SUMMARY OF THE INVENTION

It is, therefore, an object of the present invention to provide a mixed reality system capable of providing the organic movement of each object and simulation information, thereby, finally, easily performing the examination of the work efficiency of a new process, and a method of implementing the same.

Another object of the present invention is to provide a mixed reality system capable of developing a mixed reality technology required to verify a work process in virtual engineering, and supplying a portable desktop-type or whiteboard-type environment, thereby allowing the participation of a plurality of users, and a method of implementing the same

In accordance with a first aspect of the present invention, there is provided a mixed reality system, including: a camera for providing captured image information in an arbitrary work environment; a sensing unit for providing sensed information based on operation of the camera; a process simulation unit for performing simulation on part/facility/process data of the arbitrary work environment, which is stored in a process information database (DB); a process allocation unit for handling allocation status between the data and simulation information; a mixed reality visualization unit for receiving the captured information and the sensed information, determining a location of the process allocation unit, combining the captured information and sensed information with the simulation information, and then outputting resulting information; and a display-based input/output unit for displaying mixed reality output information from the mixed reality visualization unit and inputting information requested by a user.

In accordance with a second aspect of the present invention, there is provided a method of implementing a mixed reality system, including: collecting one or more work processes each including simulation information representative of allocation, selection, and temporal movement of facilities/parts in an arbitrary work environment; capturing images of the work environment using a camera in the work environment; and combining the work processes with the captured images of the work environment, and outputting resulting data in a video image form.

### BRIEF DESCRIPTION OF THE DRAWINGS

The above and other objects and features of the present invention will become apparent from the following description of embodiments given in conjunction with the accompanying drawings, in which:

FIG. 1 is a block diagram showing the configuration of a mixed reality system in accordance with an aspect of the present invention;

FIG. 2 is a perspective view of a moving body on which a camera and a display-based input/output unit of FIG. 1 are mounted;

FIG. 3 is a flowchart depicting a method of implementing mixed reality in accordance with another aspect of the present invention;

FIG. 4a illustrates an example of a screen on which the actually captured images of facilities at a work site are displayed in accordance with the present invention; and

FIG. 4b represents an example of a screen on which mixed reality is applied to the image of a facility to be installed.

### DETAILED DESCRIPTION OF THE EMBODIMENTS

A work process in accordance with the present invention should include the CAD data of a facility and a product, the working simulation of the facility, and the manufacturing process simulation of the product. In particular, the processing of data related to a commercial tool must be possible so that the commercial tool, which has been already applied to a work site, can be utilized.

In order to acquire information related to the facility data of a work site, computer vision-based semi-automatic work site registration work is simultaneously performed. This work handles accurate description based on a vision technique and user selection in order to acquire 3-dimensional geometric information related to the data of a facility adjacent to a place where a work facility will be installed.

In order to track the location and posture of a camera capturing the images of a work site, a gyro sensor and a geomagnetism sensor are employed. Rather than the absolute location of the camera, the relative relationships between other facilities and a facility to be mounted and between other facilities and the location of the camera at a place where the camera should be installed are important. Further, a signal processing technique for converting input/output from a sensor into a signal with low noise is required.

A portable desktop environment-type or white board-type system allows the participation of a plurality of users, and allows a plurality of users to evaluate the same work simultaneously, so that reliable results can be acquired. The system is configured using a camera and a monitor each having high resolutions, and a mixed reality technique is utilized so as to match the location and posture information of a camera with 3-dimensional facility data on a screen.

The embodiments of the present invention will be described with reference to the accompanying drawings below.

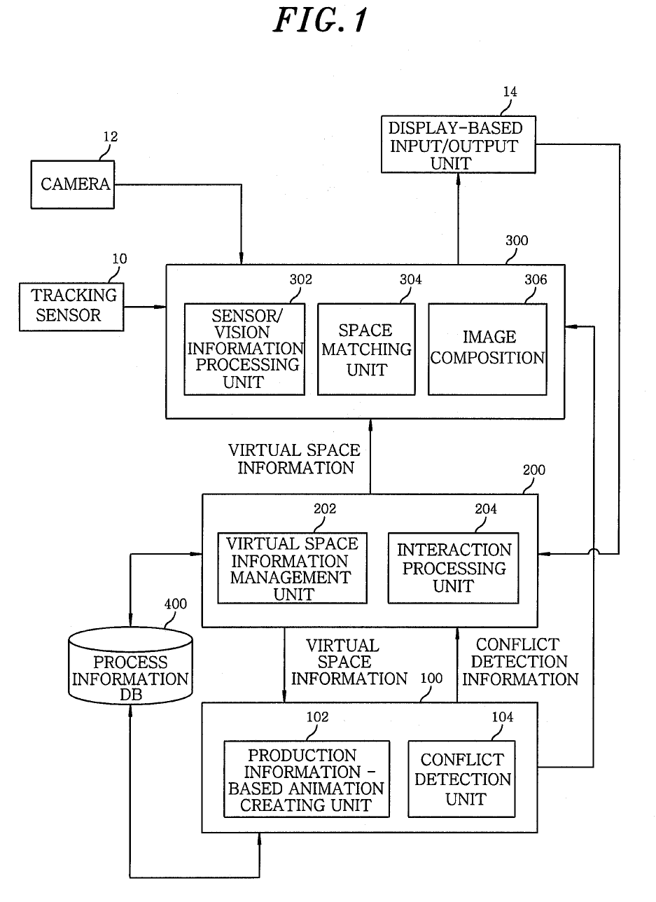

FIG. 1 is a block diagram showing the configuration of a mixed reality system in accordance with an aspect of a embodiment of the present invention. The mixed reality system includes a tracking sensor 10, a camera 12, a display-based input/output unit 14, a process simulation unit 100, a process allocation unit 200, a mixed reality visualization unit 300, and a process information DB 400.

As shown in FIG. 1, the tracking sensor 10 and the camera 12 are input exclusive devices for providing image information, captured by the camera 12, and information sensed by the tracking sensor 10 to the mixed reality visualization unit 300. Here, the sensed information refers to, for example, the location information and posture information of the camera 12. That is, when the camera 12 operates in a horizontal direction or in a vertical direction so as to capture the images of a work site, the location information and the posture information, corresponding to this operation, are acquired by the tracking sensor 10.

The tracking sensor 10 is mounted at a predetermined position on the camera 12, and includes a gyro sensor and a geomagnetism sensor (not shown) so as to track the location and posture of the camera 12 for capturing the images of the work site. Rather than the absolute location of the camera, the relative relationships between other facilities and a facility to be mounted and between other facilities and the location of the camera at a place where the camera should be installed are important. Further, a signal processing technique for converting input/output from a sensor into a signal with low noise is required.

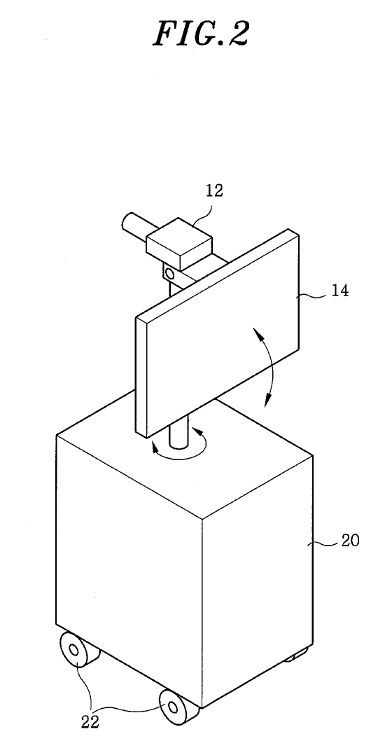

The display-based input/output unit 14 is, for example, a 20 to 40 inch touch screen monitor, and provides a function of not only displaying the image information of the mixed reality in accordance with the present invention to the outside but also receiving request information from users. This display-based input/output unit 14 is implemented to operate in a horizontal direction or a vertical direction together with the camera 12, and this has been shown in the perspective view of FIG. 2 as an example.

As shown in FIG. 2, the camera 12 and the display-based input/output unit 14 can be integrated together, and the camera 12 and the display-based input/output unit 14 can be simultaneously operated in a lateral direction or a vertical direction. That is, they are configured to move together such that a user can easily modify the location of the camera 12 for capturing images while viewing the display-based input/output unit 14. Here, the camera 12 and the display-based input/output unit 14 are installed to be operated on the upper portion of the moving body 20 having a predetermined size, and the moving body 20 includes wheels 22 on the lower portion thereof for easy movement at the work site.

With reference to FIG. 1 again, the process simulation unit 100 is in charge of performing simulation on parts/facilities/process data, and the process allocation unit 200 performs a function of processing the allocation status between data and processing simulation information. The mixed reality visualization unit 300 performs a function of receiving input from the camera 12 and the tracking sensor 10, and determining the location of the process allocation unit 200.

The configurations of the process simulation unit 100, the process allocation unit 200, and the mixed reality visualization unit 300 will be described in detail with reference to the drawing.

As shown in FIG. 1, the process simulation unit 100 includes a production information-based animation creating unit 102 and a conflict detection unit 104. The production information-based animation creating unit 102 produces temporal animation information based on the 3-dimensional geometric information and process data of respective facilities/parts, which are acquired from a process information DB 400, which will be described later. In particular, a production robot has process data in its own format, the production information-based animation creating unit 102 creates variation in the temporal geometric information of the robot by loading and processing the process data in its own format. The conflict detection unit 104 of the process simulation unit 100 performs a function of detecting conflicts between the temporal allocation of the respective facilities/parts performed by the process allocation unit 200, and conflict detection information acquired by the conflict detection unit 104 is provided to the process allocation unit 200 again.

The process allocation unit 200 includes a virtual space information management unit 202 and an interaction processing unit 204. The virtual space information management unit 202 collects variations in the temporal geometric information in the respective facilities/parts, forms a specific virtual space, and creates the temporal configurations of the respective facilities/parts. That is, the virtual space information management unit 202 recognizes the places (locations) of the respective facilities/parts (for example, a robot) in a work site, and provides the virtual space information of the facilities/parts to the process simulation unit 100 and the mixed reality visualization unit 300. The interaction processing unit 204 of the process allocation unit 200 performs a function of receiving input from the display-based input/output unit 14 and enabling the location and posture of the virtual space to be modified.

The mixed reality visualization unit 300 includes a sensor/vision information processing unit 302, a space matching unit 304, and an image combination unit 306. The sensor/vision information processing unit 302 performs a function of receiving image information from the camera 12 and sensed information from the tracking sensor 10, and then collecting and processing the current location information and posture information of the camera. The space matching unit 304 combines information, collected by the sensor/vision information processing unit 302, with virtual space information, and then allocates the virtual space information based on the surface and corresponding points of the work site. The image combination unit 306 combines the virtual space information, allocated by the space matching unit 304, with image information, from which the basic distortion of the camera is removed, in real time, and then provides resulting information to the display-based input/output unit 14.

The process information DB 400 stores various types of process information, such as part information and facility information, into a database. Further, the information are provided to the process simulation unit 100 and the process allocation unit 200.

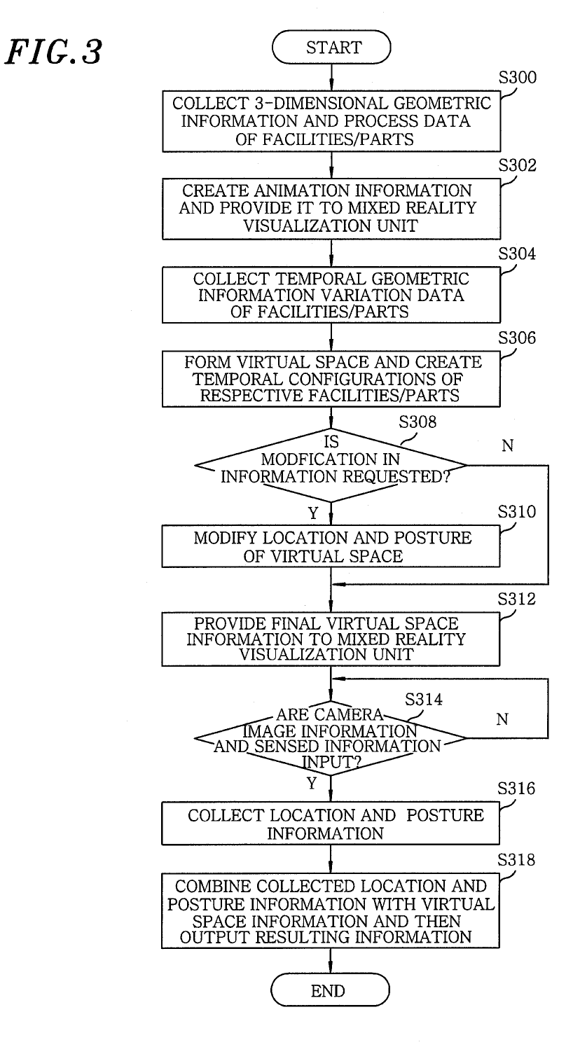

With the above-described configuration, a process of implementing a mixed reality system in accordance with another aspect of the present invention will be described in detail with reference to the flowchart of FIG. 3.

As shown in FIG. 3, at step S300 and step S302, the process simulation unit 100 collects the 3-dimensional geometric information and process data of the facilities/parts from the process information DB 400, creates animation information, and then provides it to the mixed reality visualization unit 300.

Further, at step S304 and step S306, the process allocation unit 200 collects the temporal geometric information variation data of the facilities/parts, forms a virtual space, and then creates the temporal configurations of the respective facilities/parts.

Here, at step S308, the process allocation unit 200 determines whether variation in information is requested by the display-based input/output unit 14, and, if it is found that such variation in information is requested, the process proceeds to step S310.

At step S310, the process allocation unit 200 controls the interaction processing unit 204 such that the location and posture of the virtual space is modified.

Further, at step S312, the process allocation unit 200 provides final virtual space information to the mixed reality visualization unit 300.

Meanwhile, at step S314, the mixed reality visualization unit 300 determines whether the camera image information and the sensed information have been input from the camera 12 and the tracking sensor 10, and, if it is found that the camera image information and the sensed information have been input, the mixed reality visualization unit 300 proceeds to step S316, and then collects location and posture information related to the image information and sensed information.

Thereafter, at step S318, the mixed reality visualization unit 300 provides information, in which the collected location information and posture information are combined with the virtual space information, to the display-based input/output unit 14. Therefore, the display-based input/output unit 14 can output the virtual space information, with which the location information and the posture information are combined, that is, mixed reality information, to the outside.

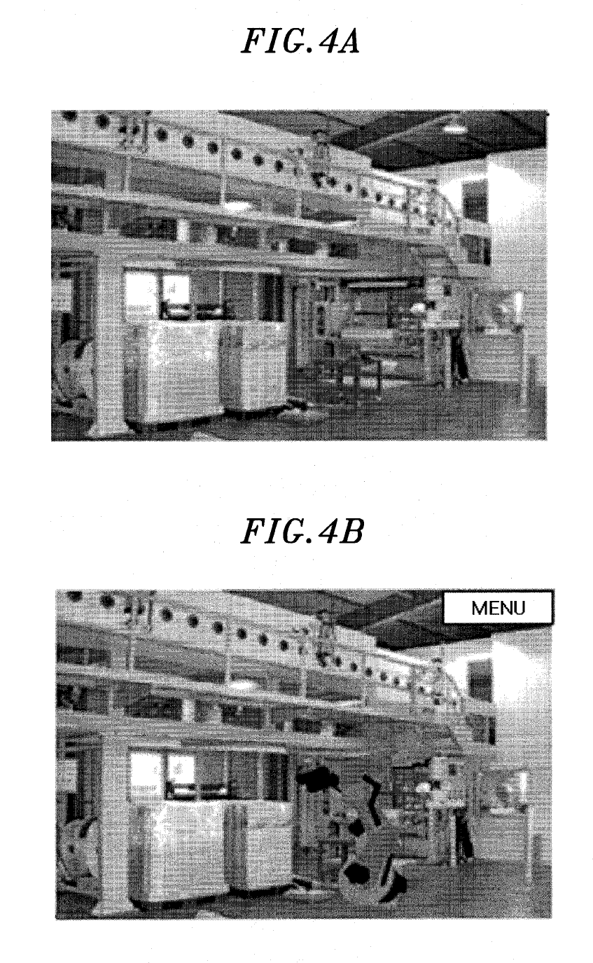

FIG. 4a shows an example of a screen on which the actual images of facilities captured by the camera 12 at a work site are displayed, and FIG. 4b illustrates an example of a screen on which virtual space information, with which the image of a facility to be installed is combined, that is, mixed reality information, is displayed.

The present invention has an advantage in that the efficiency of a process can be verified using only work site data and unique provision data of each facility/part without performing a simulation process of an entire existing commercial tool when a new process is introduced to a work site.

According to the present invention, it can be expected that the competitiveness of business can be strengthened by greatly decreasing the costs of introducing a new process.

While the invention has been shown and described with respect to the embodiments, it will be understood by those skilled in the art that various changes and modifications may be made without departing from the scope of the invention as defined in the following claims.

What is claimed is:

1. A method of implementing a mixed reality system, comprising:
collecting one or more work processes each including simulation information representative of allocation, selection, and temporal movement of facilities/parts in an arbitrary work environment;
capturing images of the work environment using a camera in the work environment; and
combining the work processes with the captured images of the work environment, and outputting resulting data in a video image form.

2. The method of claim 1, wherein the collecting one or more work processes comprises:
collecting 3-dimensional geometric information and process data of the facilities/parts, and then creating animation information;
collecting temporal geometric information variation data of the facilities/parts, forming a virtual space, and then creating temporal configurations of the facilities/parts; and
modifying a location and posture of the virtual space, if modification in information is requested by a display-based input/output unit.

3. The method of claim 1, wherein the capturing images of the work environment comprises:
collecting sensed information based on operation of the camera; and
collecting image information acquired by the camera, and location information and posture information related to the sensed information.

4. The method of claim 3, wherein the combining the work processes comprises displaying information, in which the collected location information and posture information are combined with virtual space information, to an outside using a display-based input/output unit.

5. A mixed reality system, comprising:
a camera for providing captured image information in an arbitrary work environment;
a sensing unit for providing sensed information based on operation of the camera;
a process simulation unit for performing simulation on part/facility/process data of the arbitrary work environment, which is stored in a process information database (DB);
a process allocation unit for handling allocation status between the data and simulation information;
a mixed reality visualization unit for receiving the captured information and the sensed information, determining a location of the process allocation unit, combining the captured information and sensed information with the simulation information, and then outputting resulting information; and
a display-based input/output unit for displaying mixed reality output information from the mixed reality visualization unit and inputting information requested by a user.

6. The mixed reality system of claim 5, wherein the process simulation unit comprises:
a production information-based animation creating unit for producing temporal animation information based on 3-dimensional geometric information and process data of facilities/parts, which are acquired from the process information DB; and
a conflict detection unit for detecting conflict between temporal allocations of the respective facilities/parts performed by the process allocation unit, and providing the detection results to the process allocation unit.

7. The mixed reality system of claim 5, wherein the process allocation unit comprises:
a virtual space information management unit for collecting variations in temporal geometric information of respective facilities/parts, forming a specific virtual space, and then creating temporal configurations of the respective facilities/parts; and
an interaction processing unit for receiving input from the display-based input/output unit, and then enabling a location and a position of the virtual space to be modified.

8. The mixed reality system of claim 5, wherein the mixed reality visualization unit comprises:
a sensor/vision information processing unit for receiving the image information from the camera and the sensed information from the sensing unit, and then collecting and processing current location information and posture information of the camera;
a space matching unit for combining information, collected by the sensor/vision information processing unit, with virtual space information, and then allocating the virtual space information based on a surface and corresponding points of a work site; and
an image combination unit for combining the virtual space information, allocated by the space matching unit, with image information, from which basic camera distortion is removed, in real time, and then providing resulting information to the display-based input/output unit.

9. The mixed reality system of claim 5, wherein the sensed information is location information and posture information corresponding to horizontal or vertical operation of the camera.

10. The mixed reality system of claim 5, wherein the sensing unit comprises a gyro sensor and a geomagnetism sensor so as to track a location and posture of the camera.

11. The mixed reality system of claim 5, wherein the sensing unit is a tracking sensor mounted at a predetermined location on the camera.
